(19) United States
(12) Patent Application Publication
(10) Pub. No.: US 2026/0280866 A1
(43) Pub. Date: Sep. 17, 2026

(54) Method and Apparatus for Generating Key Generation Information for a Digital Access Key for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/565,696

(22) Filed: Mar. 13, 2026

(30) Foreign Application Priority Data
Mar. 14, 2025 (DE) 10 2025 109 975.8

(51) Int. Cl. H04L 9/08; B60R 25/24

(52) U.S. Cl. CPC H04L 9/0861; B60R 25/24

(57) ABSTRACT

An apparatus and a method for generating key generation information for a digital access key for a motor vehicle provide a service request from the user terminal to a remote computing device to generate a digital access key for the motor vehicle for a predetermined service in the motor vehicle. The service request includes a service identifier that identifies a service with respect to the motor vehicle and a user of the user terminal. The apparatus and method check the service identifier in the remote computing device, provide the key generation information to the user terminal, and generate a digital access key in the user terminal for the motor vehicle for the predetermined service in the motor vehicle based on the key generation information.

### CROSS REFERENCE TO RELATED APPLICATION

This application claims priority under 35 U.S.C. §119 from German Patent Application No. 10 2025 109 975.8, filed Mar. 14, 2025, the entire disclosure of which is herein expressly incorporated by reference.

### BACKGROUND AND SUMMARY

The invention relates to a method and an apparatus for generating key generation information for a digital access key for a motor vehicle.

Document DE 10 2015 223 342 A1, for example, specifies a method for operating an authorization apparatus for a vehicle, which authorization apparatus is designed for initial communication with the vehicle.

The object of the invention is to specify an improved method and an improved apparatus for generating key generation information a digital access key for a motor vehicle.

This object is achieved in accordance with the invention by the subjects of the independent patent claims. The dependent patent claims and the description relate to advantageous embodiments of the invention.

According to a first aspect, a method for generating key generation information for a digital access key for a motor vehicle is specified.

The method according to the invention comprises the steps of providing a service request from a user terminal to a remote computing device in order to generate a digital access key for the motor vehicle for a predetermined service in the motor vehicle, the service request comprising a service identifier that identifies a service with respect to the motor vehicle and a user of the user terminal, checking the service identifier in the remote computing device, generating key generation information in the remote computing device in response to the checking, providing the key generation information to the user terminal, and generating a digital access key in the user terminal for the motor vehicle for the predetermined service in the motor vehicle based on the key generation information.

The method according to the invention is used to enable one or more user terminals for a particular service, which is carried out or is intended to be carried out in the motor vehicle, for example, a workshop visit, and to provide this user terminal with generation information for a (further) digital access key for the performance of this service or to have this generation information provided by a remote computing device. In particular, the method according to the invention provides a certain level of security which is made possible by using a separate service certificate and also by means of a service identifier and optionally a device identifier.

A user terminal, which can also be referred to as a user device, is a device or an apparatus designed to receive operator control inputs, user inputs and/or user commands and to communicate with a motor vehicle in order, in particular, to provide these operator control inputs to the motor vehicle and thereby trigger functions in the motor vehicle.

In particular, the user terminal is a portable or mobile device which is different from the motor vehicle and which can be designed, in particular, as a so-called smart device, that is to say as an apparatus having at least one processor device, for example a smartphone, a phablet or a tablet, a smart watch, smart glasses and/or a wearable, which also provides other functions, such as making calls, surfing the Internet or messaging services, for example, through applications or programs.

In particular, the user terminal is designed to trigger or perform one or more functions in relation to one or more motor vehicles, such as locking and/or unlocking one or more flaps, such as doors, and also actively opening and/or closing one or more of such flaps, as well as releasing an immobilizer, starting an engine and/or moving the motor vehicle.

Such functions or interactions with the motor vehicle, in particular those enabling access or flap control and/or movement of the motor vehicle, can also be referred to as secure and/or protected functions and are supported in or by the user terminal or are implemented therein, in particular by means of a secure element, which can also be referred to as a secure module. Such a secure element may contain both hardware components, for example, in the form of a secure processor and/or a secure storage area, and software components, for example, one or more apps, applications or programs, which interact.

In order to trigger such functions, the user terminal typically has at least one digital access key and/or this is generated during this method. In particular, such a digital access key may be based on an asymmetric cryptosystem and/or may use such a system, wherein both the motor vehicle and the user terminal have a private key and a public key which are designed to authorize or to legitimize one another.

For this purpose, the user terminal communicates with a remote computing device in order to carry out the method. Such a remote computing device or vehicle computing device is different, separate and at a distance from the motor vehicle and the user terminal. The remote vehicle computing device may include one or more servers which are also partially or completely organized in the cloud. The remote vehicle computing device can be operated, in particular, by a manufacturer of the motor vehicle and can be used, in particular exclusively, to manage such services and/or digital access keys for one or more motor vehicles.

The communication between the user terminal and the remote computing device and between the remote computing device and the motor vehicle can be carried out, in particular, via one or more wireless communication protocols or standards, in particular far-field communication protocols, such as one or more of WLAN or WIFI, satellite communication, in particular Iridium, Orbcomm and/or Thuraya, and/or mobile radio, in particular 3G, 4G, 5G, etc.

Communication between the user terminal and the motor vehicle is not provided for carrying out the method in the present case, but can take place before and/or after carrying out the method, for example when performing a function of the motor vehicle using the user terminal.

In order to carry out the method, a service request is provided from the user terminal to the remote computing device in a first step in order to generate a digital access key for the motor vehicle for a predetermined service in the motor vehicle, the service request comprising a service identifier that identifies a service with respect to the vehicle and a user of the user terminal.

The purpose of the service request is to generate a second or further, access key for the motor vehicle, which is used, exclusively, to carry out at least one predetermined service in the motor vehicle, such as a workshop visit.

To this end, the service request also includes a service identifier that identifies a service with respect to the motor vehicle and a user of the user terminal. The service identifier, which can also be referred to as a service token, thus serves to uniquely assign the user of the user terminal to the service and the motor vehicle. The service request may also contain further information, such as service identification information that uniquely identifies the service from multiple services. In particular, the user, who can be uniquely identified, for example, via a user account, was previously activated or enabled for the motor vehicle and for this particular service.

The service identifier is then checked in the remote computing device, for example, as part of a plausibility check, for example, in order to determine whether this is valid or exists, in particular for the user of the user terminal. For this purpose, the service identifier may have previously been provided to the remote computing device, for example, likewise during activation or enabling.

In a further step, solely if the checking of the service identifier was successful, key generation information is generated in the remote computing device in response to the checking.

In a further step, this generated key generation information is provided back to the user terminal.

In a further step, the digital access key is then generated in the user terminal for the motor vehicle for the predetermined service in the motor vehicle based on the key generation information.

The method according to the invention makes it possible to enable one or more user terminals for a particular service, which is carried out or is intended to be carried out in the motor vehicle, for example, a workshop visit, and to provide this user terminal with generation information for a (further) digital access key for the performance of this service or to have this generation information provided by a remote computing device. In particular, the method according to the invention provides a certain level of security which is made possible by using a separate service certificate and also by means of a service identifier and optionally a device identifier.

According to one development, the method further comprises the steps of generating generation request parameters comprising the service identifier in the remote computing device in response to the checking of the service identifier, providing the generation request parameters from the remote computing device to the user terminal, signing the generation request parameters in the user terminal using a secret key of a service certificate, providing the signed generation request parameters from the user terminal to the remote computing device, and checking the signed generation request parameters in the remote computing device using a public key of the service certificate, wherein key generation information is generated in the remote computing device in response to the checking of the signed generation request parameters.

Thus, in a further step, generation request parameters comprising the service identifier are generated in the remote computing device in response to the checking of the service request or the service identifier, in particular exclusively if this checking was successful. These generation request parameters may also include further information, such as session identification information and the service identification information, as well as further data, with respect to the user.

In a further step, these generated generation request parameters are provided from the remote computing device back to the user terminal. There, these generation request parameters are further processed and are signed in the user terminal using a secret key of a service certificate.

The service certificate is a certificate that has been created or issued exclusively for this purpose and for this service. For example, the service certificate may have been issued by an intermediate entity. In particular, the service certificate was generated prior to carrying out the steps described here, for example during activation or registration of a particular service.

In a further step, the signed generation request parameters are provided from the user terminal to the remote computing device, where they are checked using a public key of the service certificate. The newly added signature and optionally also the session can then be checked here.

This development enables particularly secure key generation.

According to one development, the step of generating a digital access key in the user terminal comprises the steps of generating an endpoint certificate comprising the service identifier in the user terminal, providing the endpoint certificate to the remote computing device, checking the validity of the service identifier in the remote computing device, and providing confirmation information for the digital access key to the user terminal and the motor vehicle in response to the checking.

The step of generating the key generation information is thus divided into a plurality of sub-steps which are described below and can be carried out both in place of generating the key generation information and in addition to it.

An endpoint certificate is first generated in the user terminal. An endpoint certificate is a certificate that creates or enables an endpoint of a certificate chain, which extends from a root, a root certificate, via one or more intermediate certificates to the endpoint, thereby creating or enabling a chain of trust. The endpoint certificate comprises the service identifier or includes it in its additional data or extension data.

This endpoint certificate with the service identifier is then provided to the remote computing device and the validity of the service identifier is checked there.

In particular, only if the checking is successful, confirmation information for the digital access key is provided from the remote computing device to the user terminal and the motor vehicle. This confirmation information can also be referred to as an attestation.

This development enables particularly secure key generation.

According to one development, the service request comprises identifier which identifies the service with respect to the motor vehicle and the user terminal.

Thus, according to this development, in addition to the service identifier, a device identifier is introduced or used and identifies the service with respect to the motor vehicle and the user terminal. The device identifier, which can also be referred to as a device token and is different from the service identifier, thus serves to uniquely assign the user of the user terminal device to the service and the motor vehicle.

The device identifier can also be optionally checked, for example in order to determine whether it is valid or exists, in particular for the user terminal. For this purpose, the device identifier may have also previously been provided to the remote computing device, as this has already been explained in the context of the service identifier.

The creation request parameters can also include the device identifier or be added during the creation thereof, in response to the checking or only if the check was successful.

This development enables particularly secure key generation.

According to one development, the endpoint certificate additionally also comprises the device identifier, wherein the checking comprises checking the validity of the device identifier in the remote computing device.

This development enables particularly secure key generation.

According to one development, the service certificate was generated in the user terminal.

A further method step is therefore provided and comprises generating a service certificate in the user terminal.

This development enables particularly secure key generation.

According to one development, the service certificate was generated using the service identifier.

In particular, the service certificate was also generated using the device identifier.

In particular, the service certificate comprises the service identifier and optionally also the device identifier or these are included in the extension data of the service certificate.

This development enables particularly secure key generation.

According to one development, the service certificate was provided from the user terminal to the remote computing device.

A further method step is therefore provided and comprises providing the previously generated service certificate from the user terminal to the remote computing device.

This development enables particularly secure key generation.

According to one development, the service certificate was provided together with a certificate chain to the remote computing device.

As previously described, a certificate chain describes a chain of multiple certificates that extends from a root, a root certificate, via one or more intermediate certificates to a or the endpoint certificate, thereby providing a chain of trust. This entire certificate chain can be managed in the user terminal and provided to the remote computing device.

This development enables particularly secure key generation.

According to one development, the method further comprises the step of checking the service certificate in the remote computing device using the certificate chain.

In particular, in this context, the service identifier and/or the device identifier can also be checked in the remote computing device.

If one or more of these checks fails, the method can be aborted and only continued if all checks are successful.

This development enables particularly secure key generation.

According to one development, the generation request parameters are signed in a secure element of the user terminal.

The user terminal may comprise, as previously described, a secure element which may also be designed to make a signature. This is carried out according to this development such that the secure element signs the generation request parameters.

Alternatively or additionally, the endpoint certificate can also be generated in the secure element of the user terminal.

This development enables particularly secure key generation.

According to a further aspect, an apparatus for generating key generation information for a digital access key for a motor vehicle is specified.

The apparatus comprises means for carrying out one or more embodiments of the method described above. In particular, the apparatus comprises one or more processor devices to carry out the method described above. In particular, the apparatus also comprises a memory in which code is stored, in a non-volatile manner, which, when executed by a processor device, causes this to carry out the method described above.

In particular, the apparatus may comprise a user terminal, a further, second user terminal and/or one or more further remote computing devices or may form a system therewith in order to carry out or at least effect the method described above. The apparatus may also comprise one or more motor vehicles and/or a motor vehicle fleet comprising a plurality of motor vehicles or may form a system therewith. In particular, the apparatus may comprise any equipment and/or any device as described above or may form a system therewith.

Further features of the invention emerge from the claims, the figures and the description of the figures. The features and combinations of features mentioned above in the description, and the features and combinations of features mentioned below in the description of the figures and/or shown in the figures alone can be used not only in the respectively specified combination but also in other combinations or on their own.

The invention will now be explained in more detail on the basis of one preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of one embodiment of a method and an apparatus for generating key generation information for a digital access key for a motor vehicle;

FIG. 2 shows a schematic flowchart of one embodiment of a method for generating key generation information for a digital access key for a motor vehicle;

FIG. 3 shows a schematic flowchart of a further embodiment of a method for generating key generation information for a digital access key for a motor vehicle;

FIG. 4 shows a schematic flowchart of a further embodiment of a method for generating key generation information for a digital access key for a motor vehicle; and

FIG. 5 shows a schematic flowchart of a further embodiment of a method for generating key generation information for a digital access key for a motor vehicle.

### DETAILED DESCRIPTION OF THE DRAWINGS

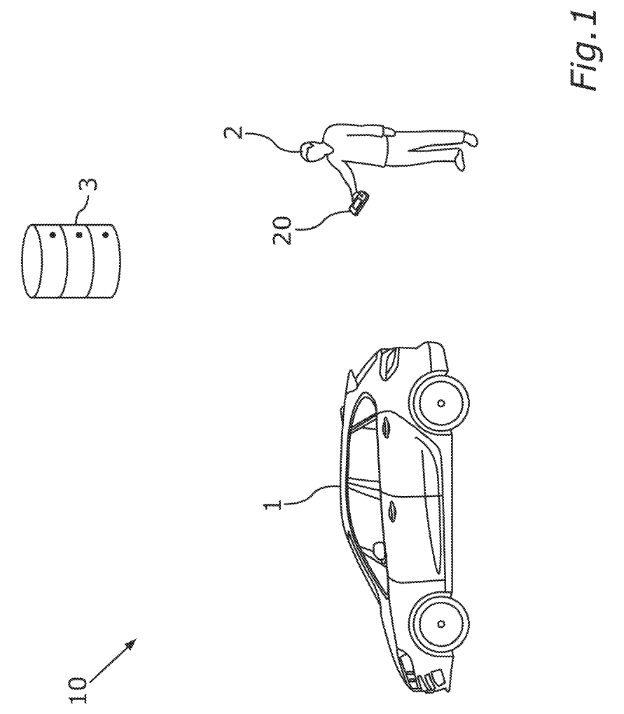

FIG. 1 shows a schematic perspective view of one embodiment of a method and an apparatus 10 for generating key generation information for a digital access key for a motor vehicle 1.

The apparatus comprises the user terminal 20 of a user 2 and a remote computing device 3. The apparatus 10 is designed to perform or at least effect the method steps described below.

The apparatus 10 is designed to provide a service request from the user terminal 20 to the remote computing device 3 in order to generate a digital access key for the motor vehicle 1 for a predetermined service in the motor vehicle, the service request comprising a service identifier that identifies a service with respect to the motor vehicle 1 and the user 2 of the user terminal 20.

The apparatus 10 is also designed to generate generation request parameters comprising the service identifier in the remote computing device 3.

The apparatus 10 is also designed to provide the generation request parameters from the remote computing apparatus 3 to the user terminal 20.

The apparatus 10 is also designed to sign the generation request parameters in the user terminal using a secret key of a service certificate.

The apparatus 10 is also designed to provide the signed generation request parameters from the user terminal 20 to the remote computing device 3.

The apparatus 10 is also designed to check the signed generation request parameters in the remote computing device 3 using a public key of the service certificate.

The apparatus 10 is also designed to generate key generation information in the remote computing device 3 in response to the checking.

The apparatus 10 is also designed to provide the key generation information to the user terminal 20.

The apparatus 10 is also designed to generate a digital access key in the user terminal 20 for the motor vehicle 1 for the predetermined service in the motor vehicle based on the key generation information.

The apparatus 10 is also designed to generate an endpoint certificate comprising the service identifier in the user terminal 20.

The apparatus 10 is also designed to provide the endpoint certificate to the remote computing device 3.

The apparatus 10 is also designed to check the validity of the service identifier in the remote computing device 3.

The apparatus 10 is also designed to provide confirmation information for the digital access key to the user terminal 20 and the motor vehicle 1 in response to the checking.

The service request may additionally comprise a device identifier which identifies the service with respect to the motor vehicle 1 and the user terminal 20.

The endpoint certificate may additionally also comprise the device identifier, wherein the checking comprises checking the validity of the device identifier in the remote computing device 3.

The apparatus 10 is also designed to generate the service certificate in the user terminal.

The apparatus 10 is also designed to generate the service certificate using the service identifier and optionally using the device identifier.

The apparatus 10 is also designed to provide the service certificate from the user terminal to the remote computing device.

The apparatus 10 is also designed to provide the service certificate together with a certificate chain to the remote computing device 3.

The apparatus 10 is also designed to check the service certificate in the remote computing device 3 using the certificate chain.

The apparatus 10 is also designed to sign the generation request parameters in a secure element of the user terminal.

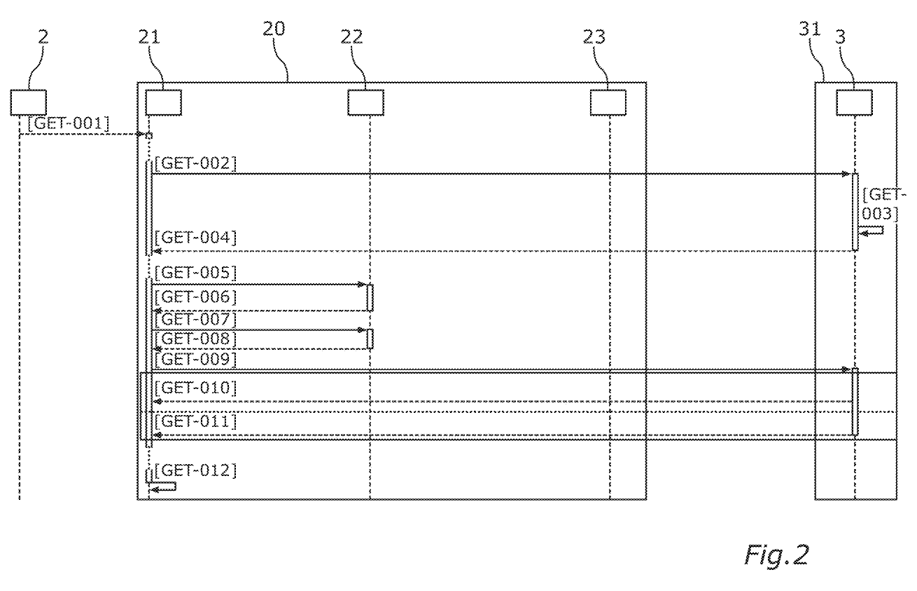

Detailed method steps as described in connection with this FIG. 1 are now explained with reference to the following FIGS. 2 to 5. In particular, the interaction of the user 2 with the user terminal 20 and of the user terminal 20 with the remote computing device 3 is described therein. The user terminal 20 has an application 21 which is also designed to receive user inputs and to provide outputs to the user 2. The user terminal 20 also has an operating system 22 on which the application is operated. The user terminal further has a secure element 23 which interacts with the operating system 22 and is responsible for the management by means of a signature. The remote computing device has a key-sharing service module 31 which is responsible for the interaction with the user terminal 20 and manages the services. The remote computing device 3 can also be referred to as a backend.

FIG. 2 shows a schematic flowchart of one embodiment of a method for generating key generation information for a digital access key for a motor vehicle 1, as shown in FIG. 1.

In these first steps GET-001 to GET-012, the service information is created and retrieved or provided. In the first four steps GET-001 to GET-004, the basic service information is retrieved, in the further seven steps GET-005 to GET-011, a status of a coupling or bond for the service is retrieved and, in the last step GET-012, the retrieved service information is output on the user terminal 20.

In a first step GET-001, a user request from the user 2, which includes a request to display service details for a particular service, is received in the user terminal 20 in the application 21.

In a further step GET-002, this request from the user is provided to the remote computing device 3 and its key-sharing service module 31. This request also includes service identification information.

In a further step GET-003, this request is processed in the remote computing device 3 and service details are compiled within this framework. These service details may also be referred to figuratively as a service card and include the service identification information, a name, a description of the service, and certain service options. For example, these service options may include a time frame such as a time limit and/or a local restriction of the service.

In a further step GET-004, the service details are provided from the key-sharing service module 31 back to the application 21 of the user terminal 20.

In a further step GET-005, the application 21 requests service information for the service identification information from the operating system 22.

In a further step GET-006, in response, a service certificate is provided from the operating system 22 to the application 21. This service certificate also includes one or more intermediate certificates, if any, and a service identifier. This service identifier uniquely identifies a service with respect to the motor vehicle 1 and the user 2 of the user terminal 20.

In a further step GET-007, the application 21 requests a device identifier from the operating system 22 and, in a further step GET-008, this device identifier is provided from the operating system 22 to the application 21. This device identifier is designed to uniquely identify the service with respect to the motor vehicle and the user terminal.

In a further step GET-009, a coupling status for the requested service is requested, together with the service identification information, the service identifier and the device identifier, from the key-sharing service module 31 of the remote computing device 3.

The next two steps are alternatives to each other, in particular exclusive alternatives.

In this case, if coupling of the user terminal is mandatory, the service status can be returned as active and the device can be returned as (still) unknown in a further step GET-010.

Alternatively, if coupling of the user terminal is not mandatory, i.e., optional, the service status inactive and any for the device can be returned in a further step GET-011.

In a further step GET-012, the service details or the service card and the coupling status are then provided or displayed for the user 2 in the application 21.

This completes the section of retrieving the service information.

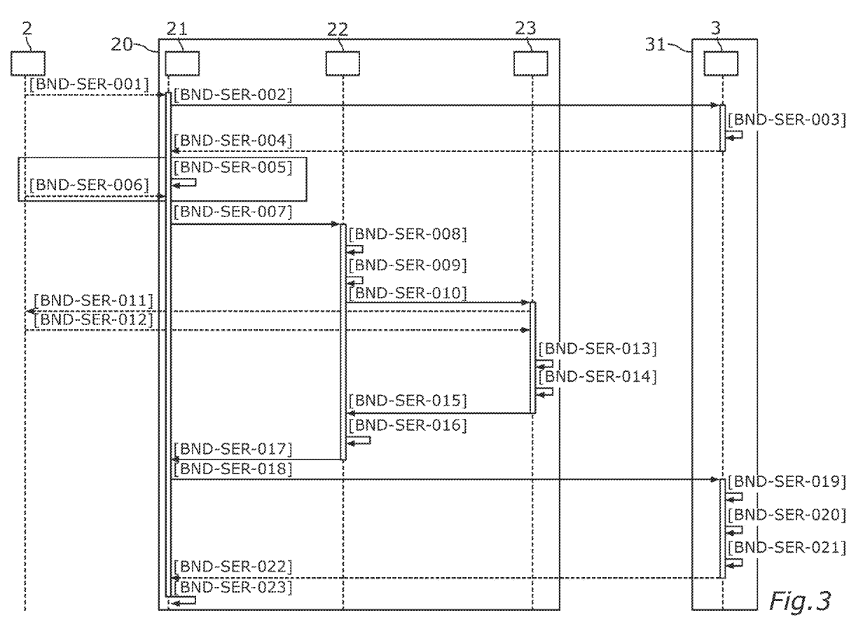

FIG. 3 shows a further flowchart of one exemplary embodiment of a method for generating key generation information for a digital access key for a motor vehicle 1. These steps shown in this FIG. 3 follow the steps shown above in FIG. 2 or the steps according to FIG. 2 have been successfully run through at least once before. The steps shown here in FIG. 3 relate to the activation of a service taking into account the previously performed request.

In a first step BND-SER-001 of the method section shown here, a user request by the user 2 is provided to the application 21 in order to activate a service.

In a further step BND-SER-002, in response, a service activation request is provided from the application 21 to the key-sharing service module 31 together with service identification information and further parameters which are also taken from the user request or can be based on it.

In a further step BND-SER-003, secure signing data are compiled in the key-sharing service module 31 for the requested activation. These signing data include actions to be taken, such as the activation of the service and associated parameters and information.

In a further step BND-SER-004, these previously compiled secure signing data are provided from the remote computing device 3 to the user terminal 20 and are processed and in particular stored in the application 21 there.

In a further step BND-SER-005, service activation details are displayed in the application 21 on the user terminal 20 for the user 2 and, in a further step BND-SER-006, a user input that confirms or enables the activation of the service is received from the user 2.

These two steps BND-SER-005 and BND-SER-006 are optional and it is also possible to continue with the following step BND-SER-007 immediately after step BND-SER-004.

In a further step BND-SER-007, a request to sign a service management request is provided from the application 21 to the operating system 22.

In a further step BND-SER-008, a service certificate is created or issued by the operating system 22. The issuing institution of the certificate is the intermediate entity which is arranged between a root certificate of a motor vehicle manufacturer and an endpoint certificate of a digital access key for the motor vehicle and which can also be referred to as an Instance CA or Instance Certificate Authority. The service certificate extends to the service identification information, the service identifier, as a result of which the service is uniquely included in the certificate, and the device identifier, as a result of which the device is uniquely included in the certificate.

In a further step BND-SER-009, service management request data are compiled from the secure signing data and the service identifier.

In a further step BND-SER-010, a request to sign the previously compiled service management request data is provided from the operating system 22 to the secure element 23.

In a further step BND-SER-011, a request to be authenticated is provided from the secure element 23 to the user 2.

In a further step BND-SER-012, a user input that successfully authenticates the user 2 is received.

In a further step BND-SER-013, the request is signed, exclusively in response to the successful authentication of the user 2 in the previous step, in the present case with the secret key of the service certificate. This key will be used in the further course of the method for processing key generation requests.

In a further step BND-SER-014, the request is signed with a digital access key. This digital access key is a valid digital access key for the motor vehicle, as shown in FIG. 1, to which the service request is directed. The digital access key may be a digital access key of a person having the right of disposal, such as an owner or proprietor, and/or a digital access key of an administrator of the motor vehicle.

In a further step BND-SER-015, the signature is provided from the secure element 23 back to the operating system 22.

In a further step BND-SER-016, a service management request is compiled from the service management request data and the signature.

In a further step BND-SER-017, the compiled service management request and the service certificate are provided from the operating system 22 back to the application 21.

In a further step BND-SER-018, the previously received service management request and additionally the service certificate and a certificate chain comprising at least one intermediate certificate from the intermediate entity are provided from the application 21 to the key-sharing service module 31 of the remote computing device 3.

In a further step BND-SER-019, the request is checked to determine whether a session between the user terminal 20 and the remote computing device 3 is valid.

In a further step BND-SER-020, the certificate chain and the service management request are verified.

In a further step BND-SER-021, the service certificate, the service identifier and the device identifier are stored or saved in the key-sharing service module 31 of the remote computing device 3. The service certificate serves to verify the subsequent key generation request and the device identifier and the service identifier serve to assign the process to a user terminal or a service.

In a further step BND-SER-022, the success of the actions carried out in the remote computing device 3 is reported back to the application 21 and, in a further step BND-SER-023, this success and the service status as active and the enabled devices together with service details are output on the user terminal 20 or provided to the user 2.

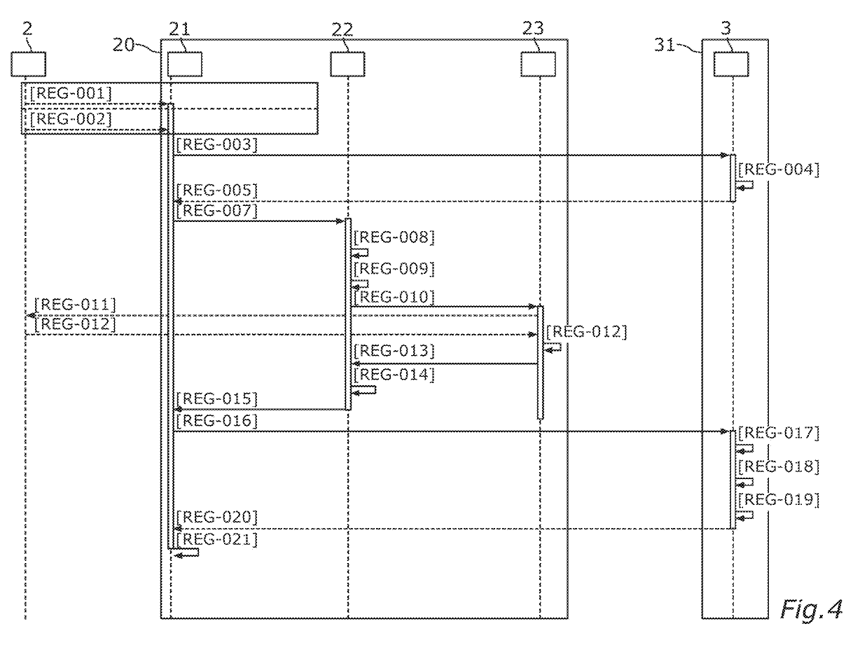

FIG. 4 shows a further flowchart of one exemplary embodiment of a method for generating key generation information for a digital access key for a motor vehicle 1. These steps shown in this FIG. 4 follow in particular the steps shown above in FIG. 3 or the steps according to FIG. 3 have been successfully run through at least once before. The steps shown here in FIG. 4 relate to registration of a new, further user terminal as well as registration for a certain service. These steps are similar to the steps described previously in connection with FIG. 3 or are predominantly identical in content.

In a first step REG-001 of the method section shown here, a request from the user 2 to activate the user terminal 20 for a service can be received in the user terminal 20. This is carried out if coupling of the user terminal 20 is mandatory.

If, on the other hand, only coupling of the service is mandatory, a request from the user 2 to register for a service can be received alternatively in the user terminal 20 in a first step REG-002. In particular, in this case, the user can thereby register for the service once, whereby all user terminals of the user are enabled for this purpose.

The following three steps REG-003 to REG-005 essentially correspond to steps BND-SER-002 to BND-SER-004 described above.

In a further step REG-003, a request to activate the user terminal 20 is provided from the application 21 to the key-sharing service module 31.

This request includes the service identification information, the service identifier and the device identifier, and optionally further information.

In a further step REG-004, secure signing data are compiled in the key-sharing service module 31 for the requested activation. These signing data include actions to be performed that are described below, such as the activation of the user terminal, and associated parameters and information, such as the service identifier and the device identifier.

In contrast to the steps shown in FIG. 3, there is no display and user confirmation in accordance with steps BND-SER-005 and BND-SER-006.

In a further step REG-005, these previously compiled secure signing data are provided from the remote computing device 3 to the user terminal 20 and are processed and stored in the application 21 there.

In a further step REG-006, a service management request to sign the previously received secure signing data is provided from the application 21 to the operating system 22.

In a further step REG-007, a service certificate is created or issued by the operating system 22. The issuing institution of the certificate is the intermediate entity which is arranged between a root certificate of a motor vehicle manufacturer and an endpoint certificate of a digital access key for the motor vehicle and which can also be referred to as an Instance CA or Instance Certificate Authority. The service certificate extends to the service identification information, the service identifier, as a result of which the service is uniquely included in the certificate, and the device identifier, as a result of which the device is uniquely included in the certificate.

In a further step REG-008, service management request data are compiled from the secure signing data and the service identifier.

In a further step REG-009, a request to sign the previously compiled service management request data is provided from the operating system 22 to the secure element 23.

In a further step REG-010, a request to be authenticated is provided from the secure element 23 to the user 2.

In a further step REG-011, a user input that successfully authenticates the user 2 is received.

In a further step REG-012, the request is signed, in particular exclusively in response to the successful authentication of the user 2 in the previous step, in the present case with the secret key of the service certificate. This key will be used in the further course of the method for processing key generation requests.

Up to this point, steps REG-006 to REG-012 correspond essentially or in terms of content to steps BND-SER-007 to BND-SER-013 described above. In a subsequent step, however, there is no step corresponding to step BND-SER-014, in which the request is also additionally signed with a digital access key.

Instead, the further steps correspond to steps BND-SER-015 to BND-SER-023 described above.

In a further step REG-013, the signature is provided from the secure element 23 back to the operating system 22.

In a further step REG-014, a service management request is compiled from the service management request data and the signature.

In a further step REG-015, the compiled service management request and the service certificate are provided from the operating system 22 back to the application 21.

In a further step REG-016, the previously received service management request and additionally the service certificate and a certificate chain comprising at least one intermediate certificate from the intermediate entity are provided from the application 21 to the key-sharing service module 31 of the remote computing device 3.

In a further step REG-017, the request is checked, in particular in order to determine whether a session between the user terminal 20 and the remote computing device 3 is valid.

In a further step REG-018, the certificate chain and the service management request are verified.

In a further step REG-019, the service certificate, the service identifier and the device identifier are stored or saved in the key-sharing service module 31 of the remote computing device 3. The service certificate serves to verify the subsequent key generation request and the device identifier and the service identifier serve to assign the process to a user terminal or a service.

In a further step REG-020, the success of the actions carried out in the remote computing device 3 is reported back to the application 21 and, in a further step REG-021, this success and the service status as active and the enabled devices together with service details are output on the user terminal 20 or provided to the user 2.

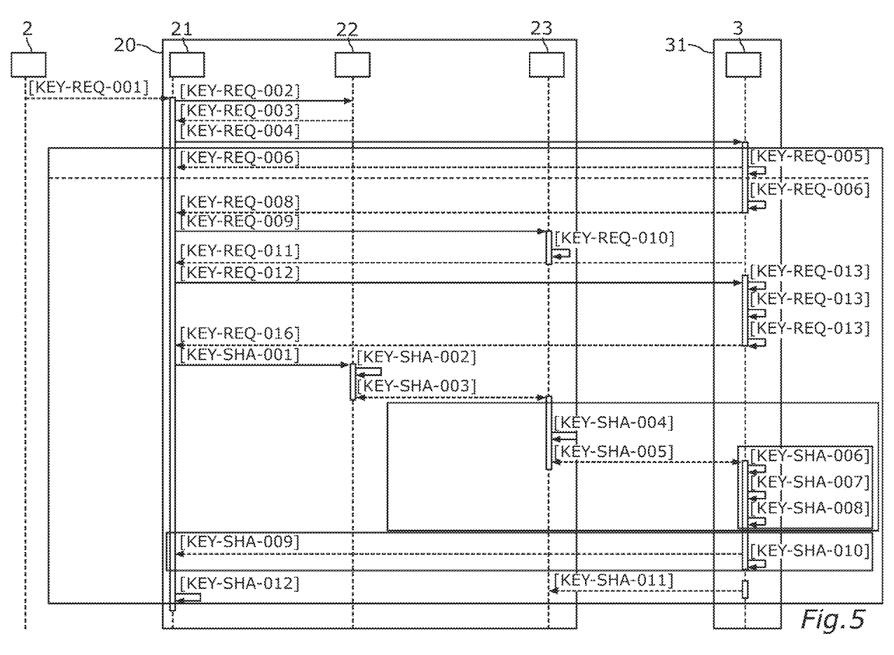

FIG. 5 shows a further flowchart of one exemplary embodiment of a method for generating key generation information for a digital access key for a motor vehicle 1. These steps shown in this FIG. 5 follow the steps shown above in FIG. 4 or the steps according to FIG. 4 have been successfully run through at least once before. The steps shown here in FIG. 5 relate to a request to generate and actual generation or sharing of a digital access key for the motor vehicle. The steps KEY-REQ-… shown here describe the processing of the request and the steps KEY-SHA-… describe the generation or sharing of the digital access key. If the user terminal 20 does not yet have a service certificate at this time, this must be set up beforehand.

In a first step KEY-REQ-001 of the method section shown here, a user request from the user 2 to trigger or start key generation for a particular service is received in the application 21 of the user terminal 20. This service has unique service identification information, on the basis of which the service can be uniquely assigned or identified. In particular, the service is that service which has previously been enabled or activated as described in connection with FIG. 3.

In a further step KEY-REQ-002, a request to obtain a service identifier for the requested service is provided from the application 21 to the operating system 22, in particular by using or providing the service identification information.

In a further step KEY-REQ-003, the service identifier for the requested service or the service identification information is provided, in response to the request, from the operating system 22 to the application 21.

In a further step KEY-REQ-004, a request to initiate or start key generation for the particular service is provided from the application 21 to the key-sharing service module 31 of the remote computing device 3. This request includes the service identification information, the previously received service identifier, the device identifier, as well as further information and in particular parameters for generation, such as a time frame.

In a further step KEY-REQ-005, this request is then processed in the key-sharing service module 31 of the remote computing device 3 and its validity is checked, in particular by checking the service identifier and/or the device identifier or the coupling stored in the remote computing device, as described in connection with FIGS. 3 and 4.

If the check was not successful, because coupling could not be checked or verified, an error message is output in the application 21 in a further step KEY-REQ-006 and the method is terminated at this point.

If, on the other hand, the check was successful and coupling could be checked or verified, the method is continued with the next step KEY-REQ-007 in which generation request parameters for generating the digital access key are generated or compiled in the key-sharing service module 31. These generation request parameters include a session identification, which can also be referred to as a nonce, the service identification information, the service identifier and optionally further information or parameters, such as personal data relating to the user 2.

In a further step KEY-REQ-008, these previously generated generation request parameters are provided to the application 21.

In a further step KEY-REQ-009, a request to sign the previously received generation request parameters is provided from the application 21 to the secure element 23.

In a further step KEY-REQ-010, these generation request parameters are signed by the secure element, with the secret key of the service certificate.

In a further step KEY-REQ-011, the signature is provided from the secure element to the application and, in a further step KEY-REQ-012, the signature is provided to the key-sharing service module 31 together with the updated generation request parameters.

In a further step KEY-REQ-013, the request is checked in the key-sharing service module 31 and the session identification is compared and the signature is checked. This can be carried out by using a public key of the service certificate.

If the check from the previous step was successful, key generation information is generated in the key-sharing service module 31 in a further step KEY-REQ-014. This key generation information is a reference to an Internet resource, such as a link or URL, which can be called for key generation.

In a further step KEY-REQ-015, the key generation information just generated is stored in the key-sharing service module 31 and the session is updated.

In a further step KEY-REQ-016, the generated key generation information with the service identification information is provided from the key-sharing service module 31 to the application 21.

The actual key generation or sharing now follows.

In a further step KEY-SHA-001, the key generation information with the service identification information is redeemed and the reference to the Internet resource is called.

In a further step KEY-SHA-002, in response, the key generation with the service identification information is started or initiated by the operating system 22.

In a further step KEY-SHA-003, key generation data are exchanged between the operating system 22 and the secure element 23 and key generation is initiated.

In a further step KEY-SHA-004, an endpoint certificate for the digital access key is generated in or by the secure element 23 and service extension data are added. These service extension data include the service identification information, the device identifier, the service identifier derived from the service identification information from the key generation information, signed service coupling data based on the service identification information, the device identifier, the service identifier and the public key of the endpoint certificate and signed with the key of the service certificate.

In a further step KEY-SHA-005, further data are exchanged between the secure element 23 and the key-sharing service module 31 and key generation continues.

Subsequently, the previously transmitted data, in particular the service extension data of the endpoint certificate, are checked or verified in the key-sharing service module 31.

For this purpose, in a further step KEY-SHA-006, the signed service coupling data are first verified with the public key of the service certificate previously stored in the key-sharing service module 31.

In a further step KEY-SHA-007, the validity of the service identifier is checked and in particular in order to determine whether it is in a list of coupled service identifiers for the user 2 in the key-sharing service module 31.

In a further step KEY-SHA-008, the validity of the device identifier is checked to determine whether it is in a list of coupled device identifiers for the user 2 in the key-sharing service module 31.

If the check or verification in at least one of steps KEY-SHA-006 to KEY-SHA-008 is not successful, in particular if the device identifier and/or service identifier cannot be checked because these are not present in the key-sharing service module 31 and/or because no and/or no matching device identifiers and/or service identifiers have been found in the service extension data of the endpoint certificate, this error is provided to the application 21 in step KEY-SHA-009 and the method is aborted in step KEY-SHA-010.

If, on the other hand, the check in steps KEY-SHA-006 to KEY-SHA-008 is successful, in a further step KEY-SHA-011, confirmation information for the digital access key is provided to the secure element 23 and the key generation process is continued between the user terminal 20 and the key-sharing service module 31, wherein, in particular, in the further course the digital access key is tracked in the remote computing device 3.

In a further, final step KEY-SHA-012, information about the generation of the digital access key and also about the service in the application 21 is provided to the user 2 and the method ends here.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle

2 User

20 User terminal

21 Application

22 Operating system

23 Secure element

3 Remote computing device

31 Key-sharing service module

GET-001 Method step

GET-002 Method step

GET-003 Method step

GET-004 Method step

GET-005 Method step

GET-006 Method step

GET-007 Method step

GET-008 Method step

GET-009 Method step

GET-010 Method step

GET-011 Method step

GET-012 Method step

BND-SER-001 Method step

BND-SER-002 Method step

BND-SER-003 Method step

BND-SER-004 Method step

BND-SER-005 Method step

BND-SER-006 Method step

BND-SER-007 Method step

BND-SER-008 Method step

BND-SER-009 Method step

BND-SER-010 Method step

BND-SER-011 Method step

BND-SER-012 Method step

BND-SER-013 Method step

BND-SER-014 Method step

BND-SER-015 Method step

BND-SER-016 Method step

BND-SER-017 Method step

BND-SER-018 Method step

BND-SER-019 Method step

BND-SER-020 Method step

BND-SER-021 Method step

BND-SER-022 Method step

BND-SER-023 Method step

REG-001 Method step

REG-002 Method step

REG-003 Method step

REG-004 Method step

REG-005 Method step

REG-006 Method step

REG-007 Method step

REG-008 Method step

REG-009 Method step

REG-010 Method step

REG-011 Method step

REG-012 Method step

REG-013 Method step

REG-014 Method step

REG-015 Method step

REG-016 Method step

REG-017 Method step

REG-018 Method step

REG-019 Method step

REG-020 Method step

REG-021 Method step

KEY-REQ-001 Method step

KEY-REQ-002 Method step

KEY-REQ-003 Method step

KEY-REQ-004 Method step

KEY-REQ-005 Method step

KEY-REQ-006 Method step

KEY-REQ-007 Method step

KEY-REQ-008 Method step

KEY-REQ-009 Method step

KEY-REQ-010 Method step

KEY-REQ-011 Method step

KEY-REQ-012 Method step

KEY-REQ-013 Method step

KEY-REQ-014 Method step

KEY-REQ-015 Method step

KEY-REQ-016 Method step

KEY-SHA-001 Method step

KEY-SHA-002 Method step

KEY-SHA-003 Method step

KEY-SHA-004 Method step

KEY-SHA-005 Method step

KEY-SHA-006 Method step

KEY-SHA-007 Method step

KEY-SHA-008 Method step

KEY-SHA-009 Method step

KEY-SHA-010 Method step

KEY-SHA-011 Method step

KEY-SHA-012 Method step

What is claimed is:

1. A method for generating key generation information for a digital access key for a motor vehicle, the method comprising:
providing a service request from a user terminal to a remote computing device to generate a digital access key for the motor vehicle for a predetermined service in the motor vehicle, the service request including a service identifier that identifies a service with respect to the motor vehicle and a user of the user terminal;
checking the service identifier in the remote computing device;
generating key generation information in the remote computing device in response to the checking;
providing the key generation information to the user terminal; and
generating a digital access key in the user terminal for the motor vehicle for the predetermined service in the motor vehicle based on the key generation information.

2. The method according to claim 1, further comprising:
generating generation request parameters including the service identifier in the remote computing device in response to the checking of the service identifier;
providing the generation request parameters from the remote computing device to the user terminal;
signing the generation request parameters in the user terminal using a secret key of a service certificate;
providing the signed generation request parameters from the user terminal to the remote computing device; and
checking the signed generation request parameters in the remote computing device using a public key of the service certificate;
wherein key generation information is generated in the remote computing device in response to the checking of the signed generation request parameters.

3. The method according to claim 1, wherein the step of generating a digital access key in the user terminal includes the following steps:
generating an endpoint certificate comprising the service identifier in the user terminal;
providing the endpoint certificate to the remote computing device;
checking the validity of the service identifier in the remote computing device; and
providing confirmation information for the digital access key to the user terminal and the motor vehicle in response to the checking.

4. The method according to claim 2, wherein the step of generating a digital access key in the user terminal includes the following steps:
generating an endpoint certificate comprising the service identifier in the user terminal;
providing the endpoint certificate to the remote computing device;
checking the validity of the service identifier in the remote computing device; and
providing confirmation information for the digital access key to the user terminal and the motor vehicle in response to the checking.

5. The method according to claim 1, wherein the service request includes a device identifier which identifies the service with respect to the motor vehicle and the user terminal.

6. The method according to claim 2, wherein the service request includes a device identifier which identifies the service with respect to the motor vehicle and the user terminal.

7. The method according to claim 3, wherein the service request includes a device identifier which identifies the service with respect to the motor vehicle and the user terminal.

8. The method according to claim 7,
wherein the endpoint certificate includes the device identifier; and
wherein the checking includes checking the validity of the device identifier in the remote computing device.

9. The method according to claim 2, wherein the service certificate is generated in the user terminal.

10. The method according to claim 4, wherein the service certificate is generated in the user terminal.

11. The method according to claim 9, wherein the service certificate is generated using the service identifier.

12. The method according to claim 10, wherein the service certificate is generated using the service identifier.

13. The method according to claim 9, wherein the service certificate is provided from the user terminal to the remote computing device.

14. The method according to claim 11, wherein the service certificate is provided from the user terminal to the remote computing device.

15. The method according to claim 13, wherein the service certificate is provided together with a certificate chain to the remote computing device.

16. The method according to claim 14, wherein the service certificate is provided together with a certificate chain to the remote computing device.

17. The method according to claim 15, further comprising:
checking the service certificate in the remote computing device using the certificate chain.

18. The method according to claim 16, further comprising:
checking the service certificate in the remote computing device using the certificate chain.

19. The method according to claim 2, wherein the signing is carried out in a secure element of the user terminal.

20. An apparatus configured to generate key generation information for a digital access key for a motor vehicle, the apparatus comprising means configured to carry out a method according to claim 1.
